(19) United States
(12) Patent Application Publication
(10) Pub. No.: US 2026/0315988 A1
(43) Pub. Date: Oct. 15, 2026

(54) WIND COLLECTING APPARATUS AND GAS TREATMENT SYSTEM

(71) Applicants: Taikisha Ltd., Tokyo (JP); Panta Rhei Co., Ltd., Nagaoka-shi (JP); National University Corporation Nagaoka University of Technology, Nagaoka-shi (JP)

(72) Inventors: Kenji KURATA, Tokyo (JP); Akihiro MIHORI, Tokyo (JP); Masahisa ISHIKAWA, Saitama (JP); Hiromichi MATSUI, Tokyo (JP); Koki NAMIKI, Tokyo (JP); Yasunori SATO, Niigata (JP); Tsutomu TAKAHASHI, Niigata (JP)

(73) Assignees: Taikisha Ltd., Tokyo (JP); Panta Rhei Co., Ltd., Nagaoka-shi (JP); National University Corporation Nagaoka University of Technology, Nagaoka-shi (JP)

(21) Appl. No.: 19/467,929

(22) Filed: Feb. 3, 2026

(30) Foreign Application Priority Data
Feb. 6, 2025 (JP) 2025-018513

(51) Int. Cl. B01D 53/04; F04D 25/06; F04D 25/08

(52) U.S. Cl. CPC B01D 53/0446; F04D 25/06; F04D 25/08; B01D 2258/06

(57) ABSTRACT

A wind collecting apparatus includes an exhaust unit opened in a plurality of directions and configured to generate a negative pressure by passing a natural wind, and an intake unit arranged on a lower side of the exhaust unit, configured to take outside air and having an intake flow path and an exhaust flow path communicating with a target space. The outside air is sucked from the intake unit via the exhaust flow path, the target space, and the intake flow path by the negative pressure generated in the exhaust unit.

### CROSS-REFERENCE TO RELATED APPLICATION(S)

This application claims priority to and the benefit of Japanese Patent Application No. 2025-018513 filed on Feb. 6, 2025, the entire disclosure of which is incorporated herein by reference.

### BACKGROUND OF THE INVENTION

### Field of the Invention

The present invention relates to a wind collecting apparatus and a gas treatment system.

### Description of the Related Art

There has been proposed a technique of generating a negative pressure by the Venturi effect using a natural wind and generating an exhaust air flow. Japanese Patent Laid-Open No. 2023-68986 discloses a wind collecting apparatus that can apply the technique to wind power. Japanese Patent Laid-Open No. 2001-193314 discloses a ventilation apparatus that applies the technique to ventilation in a columbarium.

The wind collecting apparatus of Japanese Patent Laid-Open No. 2023-68986 does not use the exhaust air flow for the space outside the wind collecting apparatus. For the ventilation apparatus of Japanese Patent Laid-Open No. 2001-193314, a configuration for introducing outside air needs to be provided separately.

### SUMMARY OF THE INVENTION

It is an object of the present invention to provide a technique for enabling air intake and exhaust using a natural wind.

According to an aspect of the present invention, there is provided a wind collecting apparatus comprising: an exhaust unit opened in a plurality of directions and configured to generate a negative pressure by passing a natural wind; and an intake unit arranged on a lower side of the exhaust unit, configured to take outside air, and having an intake flow path and an exhaust flow path communicating with a target space, wherein the outside air is sucked from the intake unit via the exhaust flow path, the target space, and the intake flow path by the negative pressure generated in the exhaust unit.

Further features of the present invention will become apparent from the following description of exemplary embodiments (with reference to the attached drawings).

### BRIEF DESCRIPTION OF THE DRAWINGS

FIG. 1 is an elevation of a wind collecting apparatus according to an embodiment of the present invention;

FIG. 2A is a sectional view taken along a line A-A in FIG. 1;

FIG. 2B is a sectional view taken along a line B-B in FIG. 1;

FIG. 3A is a sectional view taken along a line C-C in FIG. 1;

FIG. 3B is a sectional view taken along a line D-D in FIG. 1;

FIG. 3C is a sectional view taken along a line E-E in FIG. 1;

FIG. 4A is a sectional view taken along a line F-F in FIG. 1;

FIG. 4B is a sectional view taken along a line G-G in FIG. 1;

FIG. 4C is a sectional view taken along a line H-H in FIG. 1;

FIG. 5 is a sectional view taken along a line I-I in FIG. 1;

FIG. 6 is an explanatory view of a wind collecting apparatus provided with electric fans;

FIG. 7 is a sectional view taken along a line J-J in FIG. 6;

FIG. 8 is an explanatory view of a wind collecting apparatus showing another example of the configuration of an exhaust flow path and an intake flow path;

FIG. 9A is a sectional view taken along a line K-K in FIG. 8;

FIG. 9B is a sectional view taken along a line L-L in FIG. 8;

FIG. 9C is a sectional view taken along a line M-M in FIG. 8;

FIG. 10 is an explanatory view of a ventilation system to which the wind collecting apparatus shown in FIG. 1 is applied; and

FIG. 11 is an explanatory view of a gas treatment system to which the wind collecting apparatus shown in FIG. 1 is applied.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

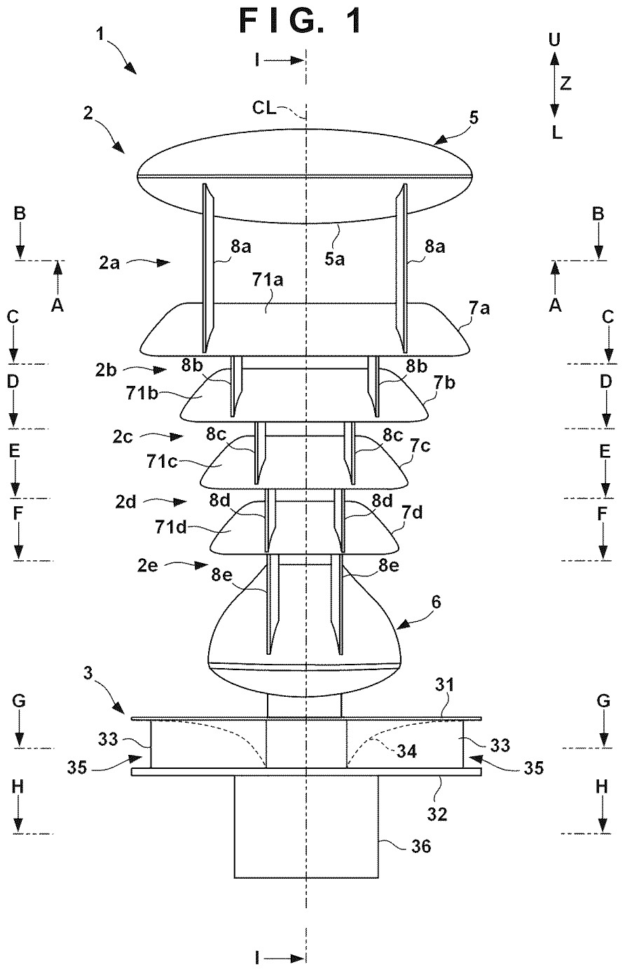

FIG. 1 is an elevation of a wind collecting apparatus 1 according to an embodiment of the present invention. The wind collecting apparatus 1 is a tower body that internally generates an airflow in the Z direction by causing a natural wind (mainly a crosswind) to pass, and is installed outdoors. In the drawings, an arrow Z indicates an up/down direction, U indicates the upper side, and L indicates the lower side.

The wind collecting apparatus 1 includes an exhaust portion 2 and an intake portion 3. In this embodiment, the exhaust portion 2 and the intake portion 3 are arranged sequentially from the upper side in the Z direction. The exhaust portion 2 includes an end member 5 on the upper side, an end member 6 on the lower side, which is apart from the end member 5 in the Z direction, and a plurality of annular bodies 7a to 7d arrayed in the Z direction between the end member 5 and the end member 6. The annular bodies 7a to 7d will sometimes be referred to as annular bodies 7 generically or without distinction. The end members 5 and 6 and the annular bodies 7 each have a circular outer shape in a planar view and are arranged coaxially on a center axis line CL of the wind collecting apparatus 1.

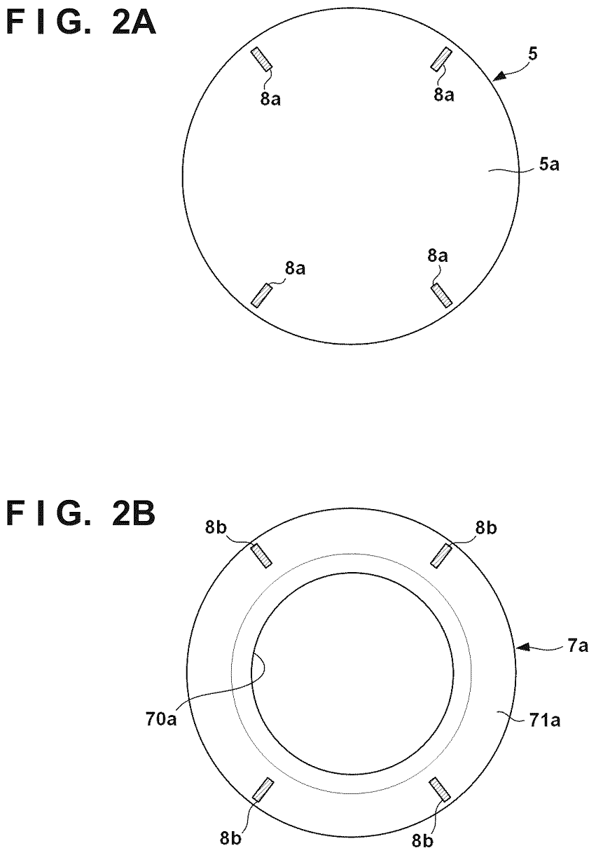

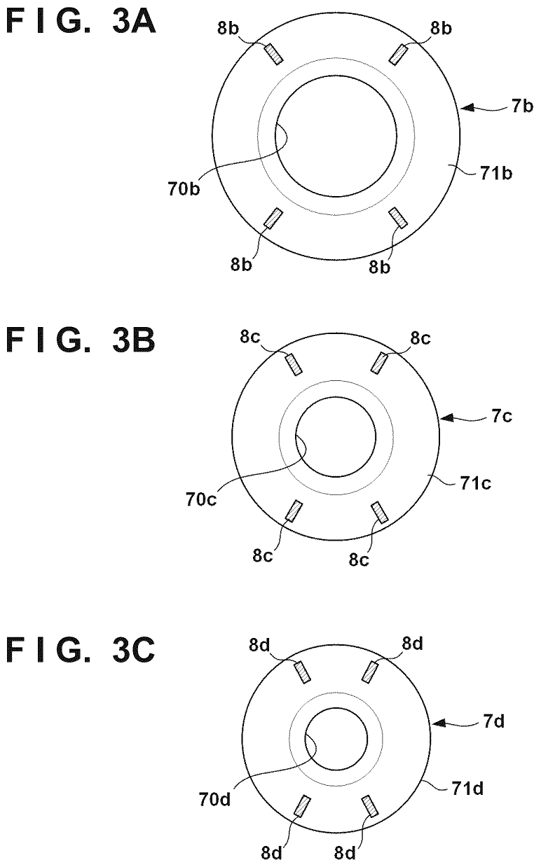

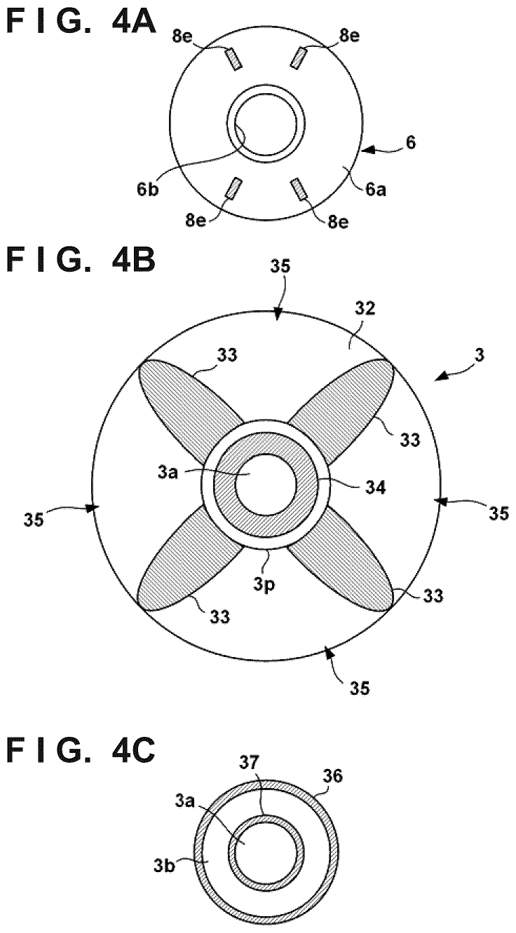

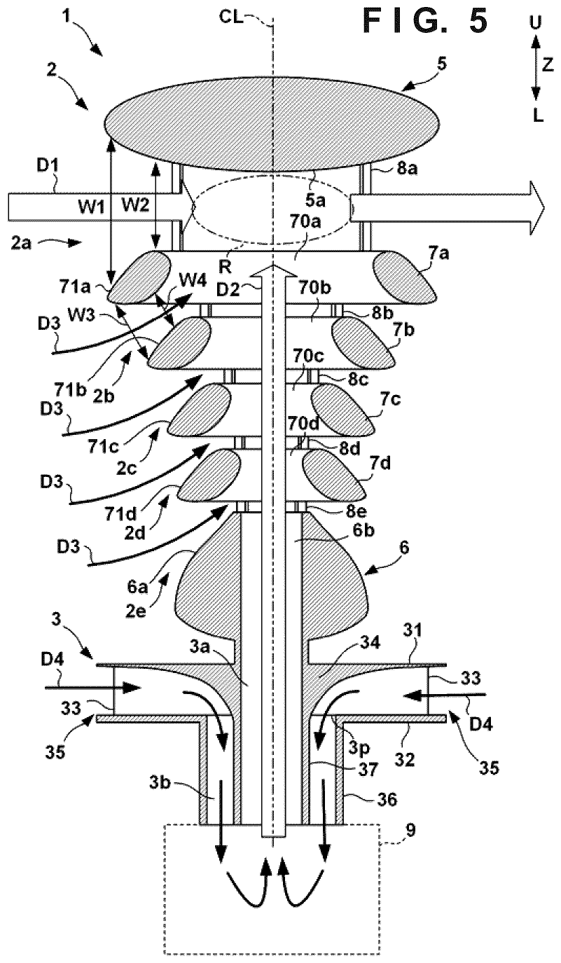

The structure of the exhaust portion 2 will be described with reference to FIGS. 2A to 4A and 5 in addition to FIG. 1. FIGS. 2A and 2B are sectional views taken along a line A-A and a line B-B in FIG. 1, respectively. FIGS. 3A to 3C are sectional views taken along a line C-C, a line D-D, and a line E-E in FIG. 1, respectively. FIG. 4A is a sectional view taken along a line F-F in FIG. 1. FIG. 5 is a sectional view taken along a line I-I in FIG. 1.

The end member 5 has a disc shape in which the central portion is thicker in the up/down direction than the peripheral portion. The end member 5 and the annular body 7a are connected by a plurality of supports 8a, and a gap 2a in the Z direction is formed between the end member 5 and the annular body 7a by the supports 8a. In this embodiment, only the plurality of supports 8a traverse the gap 2a. The plurality of supports 8a are arranged in the circumferential direction of the center axis line CL, and each support 8a is a plate-shaped member along the radial direction of the center axis line CL. Viewed in the horizontal direction, the gap 2a is opened in a plurality of directions of east, west, north, and south. Particularly, in the structure according to this embodiment, the gap 2a is substantially opened in all directions. Hence, natural winds in the directions of east, west, north, and south can pass through the gap 2a, and the lower surface of the end member 5 forms an airflow surface 5a on which the natural wind passes. The airflow surface 5a has a spherical surface projecting downward.

Each annular body 7 has a truncated cone shape as its outer shape, and has a ring structure having a hollow shell shape open along the center axis line CL. Each annular body 7 expands its diameter downward in the Z direction such that, relatively in the Z direction, the top portion on the upper side has a small diameter and the bottom portion on the lower side has a large diameter. Also, when the annular bodies 7 are compared with each other, in this embodiment, the maximum diameter of the annular body 7 on the upper side is larger than the maximum diameter of the annular body 7 on the lower side. That is, the size relationship of the diameters of the bottom portions of the annular bodies 7 is annular body 7a>annular body 7b>annular body 7c>annular body 7d.

The annular body 7a is connected to the end member 5 via the plurality of supports 8a and has an opening portion 70a at the central portion along the center axis line CL. A peripheral wall 71a of the annular body 7a faces the airflow surface 5a and forms the gap 2a.

The annular body 7b is connected to the annular body 7a via a plurality of supports 8b and has an opening portion 70b at the central portion along the center axis line CL. A gap 2b is formed between a peripheral wall 71b of the annular body 7b and the peripheral wall 71a of the annular body 7a. The plurality of supports 8b are arranged in the circumferential direction of the center axis line CL, and each support 8b is a plate-shaped member along the radial direction of the center axis line CL. Viewed in the horizontal direction, the gap 2b is opened in a plurality of directions of east, west, north, and south. Particularly, in the structure according to this embodiment, the gap 2b is substantially opened in all directions. Hence, natural winds in the directions of east, west, north, and south can enter the gap 2b.

The annular body 7c is connected to the annular body 7b via a plurality of supports 8c and has an opening portion 70c at the central portion along the center axis line CL. A gap 2c is formed between a peripheral wall 71c of the annular body 7c and the peripheral wall 71b of the annular body 7b. The plurality of supports 8c are arranged in the circumferential direction of the center axis line CL, and each support 8c is a plate-shaped member along the radial direction of the center axis line CL. Viewed in the horizontal direction, the gap 2c is opened in a plurality of directions of east, west, north, and south. Particularly, in the structure according to this embodiment, the gap 2c is substantially opened in all directions. Hence, natural winds in the directions of east, west, north, and south can enter the gap 2c.

The annular body 7d is connected to the annular body 7c via a plurality of supports 8d and has an opening portion 70d at the central portion along the center axis line CL. A gap 2d is formed between a peripheral wall 71d of the annular body 7d and the peripheral wall 71c of the annular body 7c. The plurality of supports 8d are arranged in the circumferential direction of the center axis line CL, and each support 8d is a plate-shaped member along the radial direction of the center axis line CL. Viewed in the horizontal direction, the gap 2d is opened in a plurality of directions of east, west, north, and south. Particularly, in the structure according to this embodiment, the gap 2d is substantially opened in all directions. Hence, natural winds in the directions of east, west, north, and south can enter the gap 2d.

The end member 6 is a hollow body that has a truncated cone shape as its outer shape and has an inner flow path 6b along the center axis line CL. The end member 6 expands its diameter downward in the Z direction such that, relatively in the Z direction, the top portion on the upper side has a small diameter and the bottom portion on the lower side has a large diameter. The end member 6 is connected to the annular body 7d via a plurality of supports 8e, and the inner flow path 6b is a through hole extending through the end member 6 in the Z direction. A gap 2e is formed between a peripheral wall 6a of the end member 6 and the peripheral wall 71d of the annular body 7d. The plurality of supports 8e are arranged in the circumferential direction of the center axis line CL, and each support 8e is a plate-shaped member along the radial direction of the center axis line CL. Viewed in the horizontal direction, the gap 2e is opened in a plurality of directions of east, west, north, and south. Particularly, in the structure according to this embodiment, the gap 2e is substantially opened in all directions. Hence, natural winds in the directions of east, west, north, and south can enter the gap 2e.

The structure of the intake portion 3 will be described with reference to FIGS. 4B and 4C in addition to FIGS. 1 and 5. FIG. 4B is a sectional view taken along a line G-G in FIG. 1, and FIG. 4C is a sectional view taken along a line H-H in FIG. 1.

The intake portion 3 includes a top plate portion 31 and a bottom plate portion 32. The top plate portion 31 and the bottom plate portion 32 are members having a circular plate shape with respect to the center axis line CL as the center. An opening portion 3p to pass intake air is formed at the center of the bottom plate portion 32. A plurality of partition portions 33 and an intake guide portion 34 are provided between the top plate portion 31 and the bottom plate portion 32. The plurality of partition portions 33 are arranged in the circumferential direction of the center axis line CL to connect the top plate portion 31 and the bottom plate portion 32 and divide the gap between these in the circumferential direction of the center axis line CL. A plurality of outside air intakes 35 are formed between the adjacent partition portions 33.

The intake guide portion 34 has, as its outer shape, a truncated cone shape expanding its diameter from the lower side to the upper side, and the diameter of the lower end portion is smaller than the diameter of the opening portion 3p. In the intake guide portion 34, an exhaust flow path 3a extending through the intake portion 3 along the center axis line CL is formed. The exhaust flow path 3a communicates with the inner flow path 6b.

The intake portion 3 further includes a double tube structure with an outer tube portion 36 and an inner tube portion 37, each of which has a cylindrical shape along the center axis line CL. The exhaust flow path 3a is formed by the inner tube portion 37, and the intake flow path 3b is formed between the outer tube portion 36 and the inner tube portion 37 to surround the exhaust flow path 3a. The intake flow path 3b communicates with outside air through the opening portion 3b and the intakes 35.

The function of the wind collecting apparatus 1 will be described with reference to FIG. 5. FIG. 5 assumes a case where the wind collecting apparatus 1 performs supply and exhaust of air (outside air) for a target space 9. The exhaust flow path 3a and the intake flow path 3b communicate with the target space 9.

Assume a case where a crosswind acts on the wind collecting apparatus 1. An arrow D1 in FIG. 5 exemplifies the direction of a crosswind. In the gap 2a, an interval W2 on the inner side is narrower than an interval W1 on the outer side in the radial direction of the center axis line CL. When the crosswind D1 passes through the gap 2a, the flow velocity increases at the center in the radial direction of the center axis line CL and, as a result, the pressure at the central portion lowers (Bernoulli's principle). A negative pressure region R is generated at the central portion of the gap 2a. When the negative pressure region R is generated, an upward current D2 is generated on the center axis line CL of the wind collecting apparatus 1.

Also, in the gap 2b as well, an interval W4 on the inner side is narrower than an interval W3 on the outer side in the radial direction of the center axis line CL. Hence, a negative pressure is generated in the annular body 7a, and generation of the upward current D2 is promoted. The space between the peripheral wall 71a and the peripheral wall 71b tilts upward to the inner side in the radial direction of the center axis line CL. The crosswind D1 flows into the gap 2b upward to the inner side in the radial direction of the center axis line CL, as indicated by a crosswind D3. Hence, even in this point, generation of the upward current D2 is promoted. The same phenomenon occurs in the gaps 2c to 2e as well. As described above, since the size relationship of the diameters of the bottom portions of the annular bodies 7 is annular body 7a>annular body 7b>annular body 7c>annular body 7d, the effect of promoting generation of the upward current D2 is further improved.

When the negative pressure region R and the upward current D2 are generated, air in the target space 9 is exhausted through the path of exhaust flow path 3a→inner flow path 6b→opening portions 70d to 70a of annular bodies 7d to 7a→negative pressure region R. When the air in the target space 9 is exhausted, the pressure in the target space 9 changes to a negative pressure, and outside air indicated by an arrow D4 is sucked from the intakes 35 into the target space 9 via the intake flow path 3b. The air taken downward into the target space 9 changes its airflow direction upward and is exhausted from an exhaust flow path 4a.

Thus, in this embodiment, it is possible to perform air intake and exhaust using a natural wind without needing power.

Note that in this embodiment, the annular bodies 7 are formed by four stages of annular bodies 7a to 7d, but one stage may suffice, or two, three, or five or more stages may be used. Also, the exhaust portion 2 may not include the annular bodies 7.

### Second Embodiment

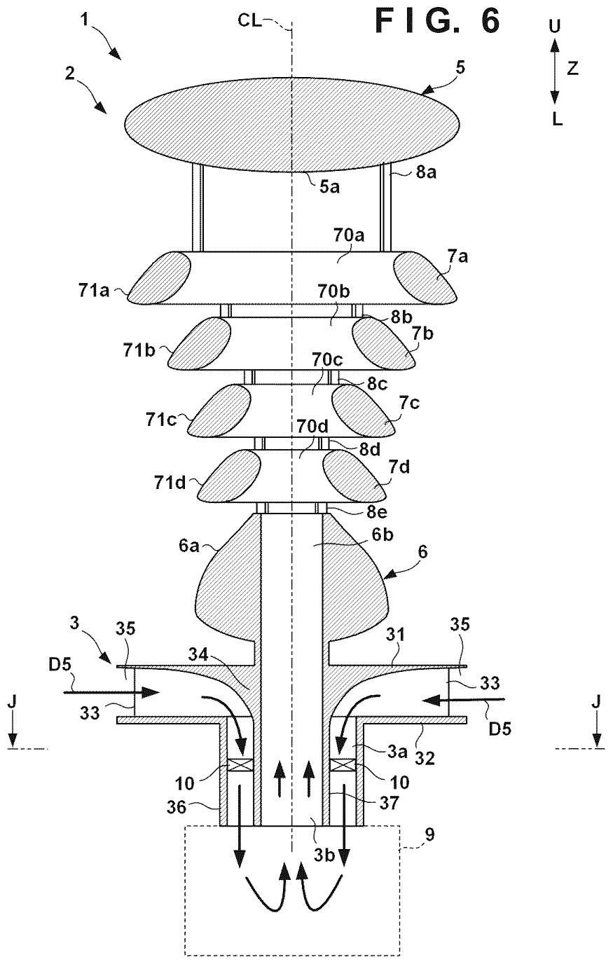

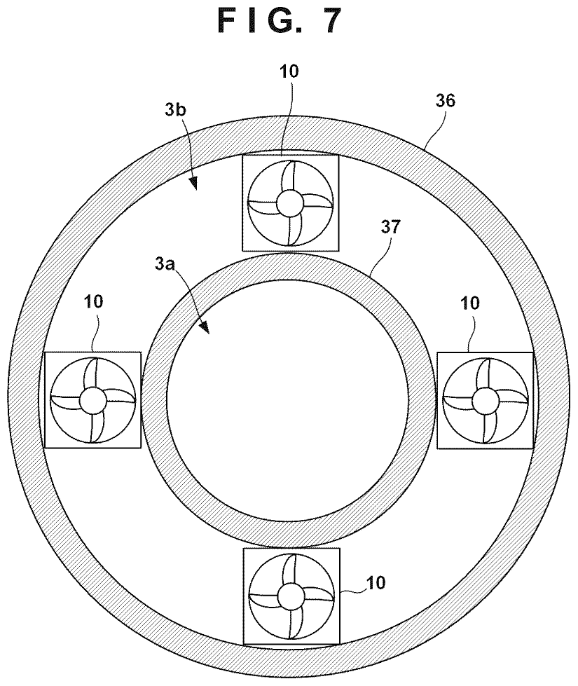

In the first embodiment, the air intake and exhaust capability lowers during a period of weak natural winds. An electric fan that takes outside air from an intake portion 3 may be provided to promote air intake by the electric fan during a period of weak natural winds. FIG. 6 is an explanatory view of a wind collecting apparatus 1 provided with electric fans 10, and corresponds to the sectional view shown in FIG. 5. FIG. 7 is a sectional view taken along a line J-J in FIG. 6.

In the wind collecting apparatus 1 according to this embodiment, a plurality of electric fans 10 are installed in an intake flow path 3b. The plurality of electric fans 10 are arranged in the circumferential direction of a center axis line CL. During a period of weak natural winds, the electric fans 10 are driven to promote air intake. Since gaps are formed between the adjacent electric fans 10, the electric fans 10 never become an obstacle for air intake in a stop state.

### Third Embodiment

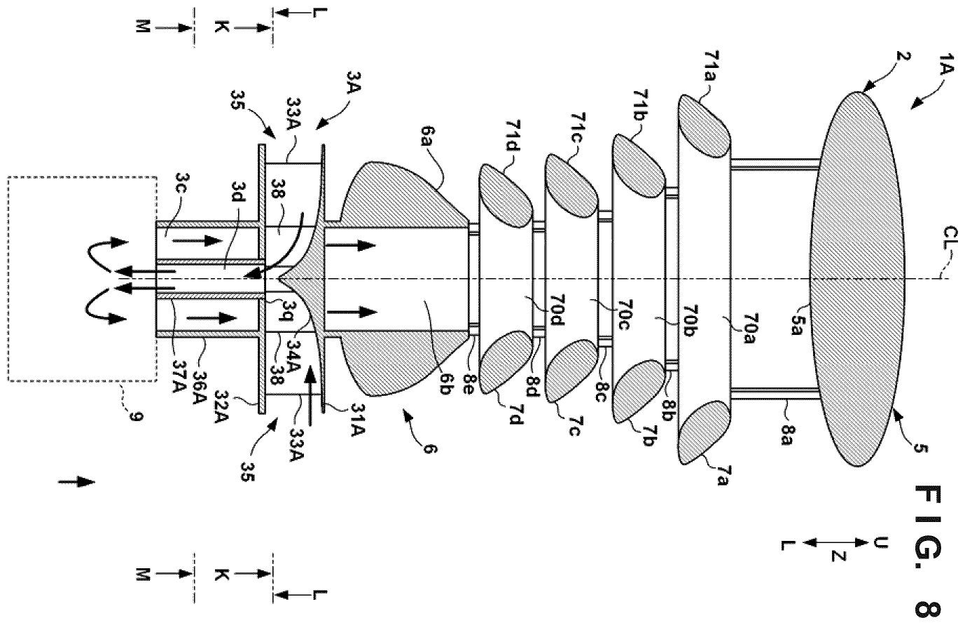

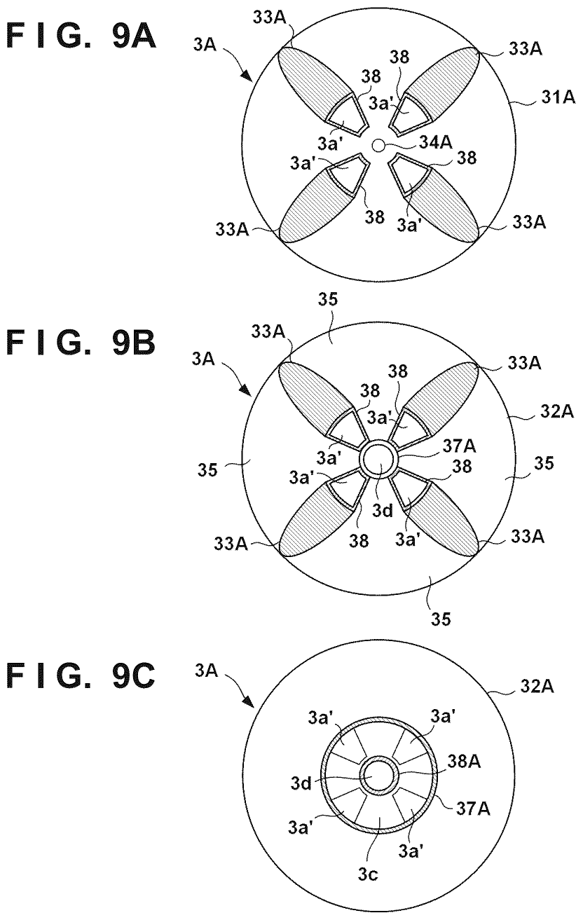

In the first embodiment, the intake flow path 3b is formed outside the exhaust flow path 3a, but a reverse arrangement is also possible. FIG. 8 is an explanatory view of a wind collecting apparatus 1A according to this embodiment, and corresponds to the sectional view shown in FIG. 5. FIGS. 9A to 9C are sectional views taken along a line K-K, a line L-L, and a line M-M in FIG. 8, respectively.

The wind collecting apparatus 1A basically has the same configuration as the wind collecting apparatus 1. Different components will be described below. The wind collecting apparatus 1A includes an exhaust portion 2 and an intake portion 3A. The exhaust portion 2 has the same configuration as the exhaust portion 2 of the wind collecting apparatus 1 except that the size in the radial direction is large as a whole.

The intake portion 3A includes a top plate portion 31A and a bottom plate portion 32A. The top plate portion 31A and the bottom plate portion 32A are members having a circular plate shape with respect to a center axis line CL as the center. An opening portion 3q to pass intake air is formed at the center of the bottom plate portion 32A. A plurality of partition portions 33A, an intake guide portion 34A, and a plurality of relay tubes 38 are provided between the top plate portion 31A and the bottom plate portion 32A. The plurality of partition portions 33A are arranged in the circumferential direction of the center axis line CL to connect the top plate portion 31A and the bottom plate portion 32A and divide the gap between these in the circumferential direction of the center axis line CL. A plurality of outside air intakes 35 are formed between the adjacent partition portions 33A.

The intake guide portion 34A has, as its outer shape, a conical shape expanding its diameter from the lower side to the upper side. The plurality of relay tubes 38 are arranged inside the partition portions 33A in correspondence with the plurality of partition portions 33A, and form an exhaust flow path 3c extending through the top plate portion 31A and the bottom plate portion 32A in the Z direction. The exhaust flow path 3c communicates with an inner flow path 6b.

The intake portion 3A further includes a double tube structure with an outer tube portion 36A and an inner tube portion 37A, each of which has a cylindrical shape along the center axis line CL. An intake flow path 3d is formed by the inner tube portion 37A, and the exhaust flow path 3c is formed between the outer tube portion 36A and the inner tube portion 37A to surround the intake flow path 3d. The inner tube portion 37A is airtightly inserted into the opening portion 3q. The intake flow path 3d communicates with outside air through the intakes 35.

The function of the wind collecting apparatus 1A is the same as the wind collecting apparatus 1. However, as for the airflow in the intake portion 3A, in this embodiment, outside air taken through the intakes 35 flows downward through the intake flow path 3d along the center axis line CL, and is folded back in a target space 9 and exhausted through the path of exhaust flow path 3c outside intake flow path 3d→inner flow path 6b.

### Fourth Embodiment

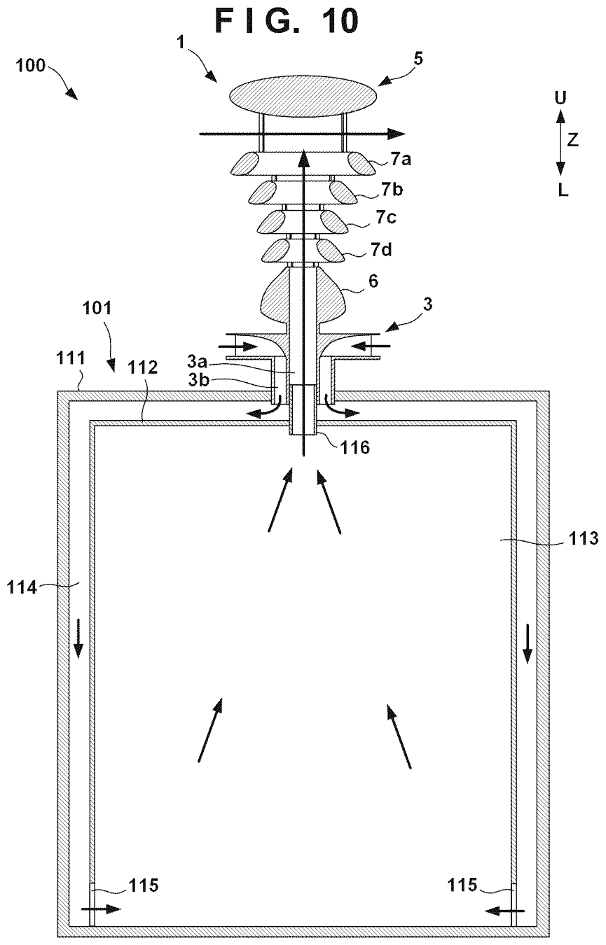

An application example of a wind collecting apparatus 1 will be described. FIG. 10 is an explanatory view of a ventilation system 100 to which the wind collecting apparatus 1 is applied. The wind collecting apparatus 1 is installed on the top portion of a building 101. The building 101 has a double wall structure of an outer wall 111 and an inner wall 112, and an internal space 113 of the building 101 is defined by the inner wall 112.

The wind collecting apparatus 1 is used as a ventilation apparatus that performs ventilation in the internal space 113 as a target space. An exhaust flow path 3a of the wind collecting apparatus 1 communicates with the internal space 113 via a pipe 116 extending through the inner wall 112, and an intake flow path 3b communicates with a gap 114 between the outer wall 111 and the inner wall 112. An inlet port 115 is formed at the lower end portion of the inner wall 112.

By a crosswind outside the building 101, an upward current is generated in the wind collecting apparatus 1 based on the principle described with reference to FIG. 5, and air in the internal space 113 is thus exhausted to the outside via the pipe 116 and the wind collecting apparatus 1. When the air in the internal space 113 is exhausted, the pressure in the internal space 113 changes to a negative pressure, and outside air is sucked from intakes 35 into the internal space 113 via the inlet port 115, the gap 114, and the intake flow path 3b. This enables ventilation in the internal space 113.

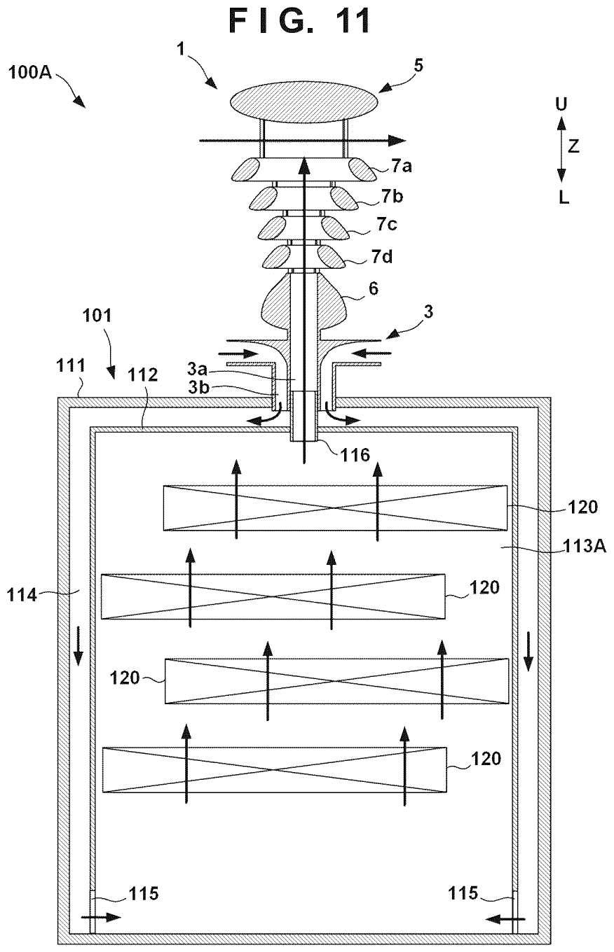

Another application example of the wind collecting apparatus 1 will be described next. FIG. 11 is an explanatory view of a gas treatment system 100A to which the wind collecting apparatus 1 is applied. A gas treatment system 100A has a structure in which the internal space 113 of the building 101 of the ventilation system 100 is used as a gas treatment unit 113A. In the gas treatment unit 113A, a plurality of adsorbers 120 configured to adsorb a specific component in air are arranged. Each adsorber 120 has a plate-or block-shaped form extended in the horizontal direction. The plurality of adsorbers 120 are arranged apart in the Z direction.

Each adsorber 120 includes, for example, an adsorbent, and a support body such as a container that supports the adsorbent. The component to be adsorbed can be at least one of, for example, nitrogen, oxygen, argon, carbon dioxide, nitrogen oxide, and sulfur oxide. In order to adsorb carbon dioxide, for example, an amine-based material, a polymer material, or an inorganic material can be used as the adsorbent.

In the gas treatment system 100A, air is passed through the adsorbers 120, thereby causing the adsorbers to adsorb a specific component in the air. By a crosswind outside the building 101, an upward current is generated in the wind collecting apparatus 1 based on the principle described with reference to FIG. 5, and air in the gas treatment unit 113A is thus exhausted to the outside via the pipe 116 and the wind collecting apparatus 1. When the air in the gas treatment unit 113A is exhausted, the pressure in the gas treatment unit 113A changes to a negative pressure, and outside air is sucked from the intakes 35 into the gas treatment unit 113A via the inlet port 115, the gap 114, and the intake flow path 3b.

The airflow in the gas treatment unit 113A changes to an upward current from the inlet port 115 to the pipe 116, and when the air passes through the adsorbers 120, a predetermined component in the air is adsorbed by the adsorbents in the adsorbers 120. When the adsorption progresses, the adsorbers 120 are extracted from the gas treatment unit 113A, and desorption of the adsorbed component is performed, thereby collecting the component.

Note that in this embodiment, an application example of the wind collecting apparatus 1 has been exemplified, but the wind collecting apparatus 1A can also employ a similar application example.

While an embodiment has been described, the invention is not limited to the foregoing embodiments, and various variations/changes are possible within the spirit of the invention.

What is claimed is:

1. A wind collecting apparatus comprising:
an exhaust unit opened in a plurality of directions and configured to generate a negative pressure by passing a natural wind; and
an intake unit arranged on a lower side of the exhaust unit, configured to take outside air, and having an intake flow path and an exhaust flow path communicating with a target space,
wherein the outside air is sucked from the intake unit via the exhaust flow path, the target space, and the intake flow path by the negative pressure generated in the exhaust unit.

2. The wind collecting apparatus according to claim 1, wherein
the exhaust unit comprises:
a first end member;
a second end member on a side of the intake unit, which is apart from the first end member in an up/down direction; and
a plurality of annular bodies arrayed between the first end member and the second end member coaxially in the up/down direction,
each annular body has an outer shape with a diameter expanded from a side of the first end member to a side of the second end member,
the second end member includes an inner flow path communicating with the exhaust flow path,
a gap between adjacent annular bodies is opened in a plurality of directions, and
the first end member includes an airflow surface facing a peripheral wall of an annular body adjacent to the first end member among the plurality of annular bodies such that a gap is formed between the airflow surface and the peripheral wall to allow natural wind to pass therethrough.

3. The wind collecting apparatus according to claim 2, wherein
the inner flow path, the exhaust flow path, and the intake flow path are arranged coaxially in the up/down direction.

4. The wind collecting apparatus according to claim 3, wherein
the exhaust flow path and the intake flow path form a double tube structure in which one of the exhaust flow path and the intake flow path surrounds the other.

5. The wind collecting apparatus according to claim 1, further comprising an electric fan configured to cause the intake unit to take the outside air.

6. The wind collecting apparatus according to claim 1, wherein
the wind collecting apparatus is a ventilation apparatus configured to perform ventilation in the target space.

7. A gas treatment system comprising:
a gas treatment unit in which an adsorber configured to adsorb a specific component in air is arranged; and
a wind collecting apparatus configured to supply the air to the gas treatment unit and exhaust the air from the gas treatment unit,
wherein the wind collecting apparatus comprises:
an exhaust unit opened in a plurality of directions and configured to generate a negative pressure by passing a natural wind; and
an intake unit arranged on a lower side of the exhaust unit, configured to take outside air, and having an intake flow path and an exhaust flow path communicating with the gas treatment unit,
wherein the outside air is sucked from the intake unit via the exhaust flow path, the gas treatment unit, and the intake flow path by the negative pressure generated in the exhaust unit.

8. The gas treatment system according to claim 7, wherein
the specific component is at least one of nitrogen, oxygen, argon, carbon dioxide, nitrogen oxide, and sulfur oxide.
